(19) United States
(12) Patent Application Publication
(10) Pub. No.: US 2025/0035158 A1
(43) Pub. Date: Jan. 30, 2025

(54) PHOSPHATING AND SOLID LUBRICATION TO REDUCE WEAR IN BEARINGS

(71) Applicant: Caterpillar Inc., Peoria, IL (US)

(72) Inventors: Swetha Suresh, Chennai (IN); Ebi Bernard, Arakkonam (IN); Tamilmurasu Annadurai, Pudukkottai (IN); Hyung Kyu Yoon, Peoria, IL (US)

(73) Assignee: Caterpillar Inc., Peoria, IL (US)

(21) Appl. No.: 18/361,356

(22) Filed: Jul. 28, 2023

(51) Int. Cl. F16C 33/66; F16C 43/04

(52) U.S. Cl. CPC F16C 33/6696; F16C 43/04

(57) ABSTRACT

A tricone bit having one or more bearings with deposited lubricant layers is disclosed. The lubricant layers may comprise one or both of a metal-phosphate and/or solid lubricant. The lubricant layers may be disposed on one or more of the bearings, the journal bases, and/or the cones. The lubricant layers can also be used for applications of bearings other than for tricone bits. The deposited lubricant layers may be more persistent lubrication for tricone bits, such as air-cooled tricone bits, compared to conventional lubricants for tricone bits. The metal-phosphate layer may include one or more of zinc phosphate, manganese phosphate, iron phosphate, or the like. The solid lubricant may include one or more inorganic fullerenes, tungsten disulfide, molybdenum disulfide, graphite, graphene, or the like.

### TECHNICAL FIELD

The present disclosure relates to bearings for reducing friction between moving parts. More specifically, the present disclosure relates to phosphating and applying solid lubrication to components of bearings, such as those used in tricone bits.

### BACKGROUND

Tricone bits are used in a variety of drilling and digging applications, such as mining and mineral retrieval activities. For example, tricone bits may be used to drill deep bores for hydraulic fracturing applications to retrieve oil. Tricone bits include three cones in an assembly with teeth or other cutting surfaces disposed on the three cones. The three cones are each coupled rotatably to a journal base using one or more bearing components to reduce friction and heat while the cones rotate. During operation, the cones rotate in an intermeshing fashion with each other, and when in contact with the earth, the cones and the teeth thereon cut into dirt, rock, and other minerals. In this way tricone bits dig into the surface of the earth.

During operation, tricone bits are often subject to high levels of pressure and heat. Additionally, the rotation of the tricone bits and the digging process expend a large amount of energy and generate high levels of heat. In this harsh operating environment, the tricone bits experience a high level of wear and tear of its internal components, such as the bearings disposed between the cones and the journal base. This can reduce the operating lifetime of the tricone bits, resulting in costly downtime of mining and/or oil exploration operations, as well as incurring costs of additional tricone bits. Thus, it is desirable to improve the operating lifetime of the tricone bits by further reducing friction between the cones and the corresponding journal bases.

Additionally, air-cooled tricone bits have advantages over sealed oil cooled tricone bits, such as a more compact form factor and greater load ratings. However, for air-cooled tricone bits, which are open systems not cooled by grease or oil, the operating lifetime can be curtailed due to a lack of lubrication of the internal components of the tricone bits. Therefore, it is particularly desirable to reduce friction within the internal parts of air-cooled tricone bits, which otherwise do not have any persistent lubrication during operation.

One mechanism for lubricating the internal components of a tricone bit is described in U.S. Pat. No. 5,456,327 (hereinafter referred to as “the '327 patent”). The '327 patent describes an elastomeric seal of a tricone bit coated with a variety of materials, including metal disulfides. While the '327 patent provides a sealant for the elastomeric seal that may enhance the lifetime of the elastomeric seal, the '347 patent does not discuss advantageous coatings of the internal components of the tricone bit, such as the bearings of the tricone bit. Thus, the '327 patent fails to provide a solution to wear and tear of major components of the tricone bit, such as the raceways of the bearings and the bearing balls and/or rollers.

Examples of the present disclosure are directed toward overcoming one or more of the deficiencies noted above.

### SUMMARY

In an example of the disclosure, a tricone bit assembly includes a first journal base having a first surface region, wherein the first surface region includes a metal-phosphate layer and a solid lubricant layer overlying the metal-phosphate layer. The tricone bit further includes a first cone rotatably mounted on the first journal base and configured to rotate on a first axis. The tricone bit still further includes at least one rolling element disposed between the first journal base and the first cone, such that the at least one rolling element enables the first cone to rotate relative to the first journal, wherein the at least one rolling element is substantially in contact with at least one of the solid lubricant layer or the metal-phosphate layer.

In another example of the disclosure, a method of fabricating a tricone bit, includes fabricating a first journal base with an outer surface and depositing a first metal-phosphate layer on the outer surface of the first journal base. The method further includes depositing a first lubricant layer on top of the first metal-phosphate layer, fabricating a first cone, and assembling the first cone over the first solid lubricant layer disposed on the first journal base with at least one rolling element disposed between the first solid lubricant layer and the first cone.

In yet another example of the disclosure, a bearing includes an inner raceway surface region, wherein the inner raceway surface region includes a metal-phosphate layer and a solid lubricant layer overlying the metal-phosphate layer and an outer raceway surface region rotatably configured to rotate relative to the inner raceway surface region. The bearing further includes at least one rolling element disposed between the inner raceway surface region and the outer raceway surface region, such that the at least one rolling element enables the outer raceway surface to rotate relative to the inner raceway surface region, wherein the at least one rolling element is substantially in contact with at least one of the solid lubricant layer or the metal-phosphate layer.

### BRIEF DESCRIPTION OF DRAWINGS

FIG. 1 is a schematic illustration of an example tricone bit, in accordance with example embodiments of the disclosure.

FIG. 2 is a schematic illustration of a journal base and bearings of a cone of the tricone bit of FIG. 1, in accordance with example embodiments of the disclosure.

FIG. 3 is a schematic illustration of a tricone assembly with a cross section of one cone of the tricone bit of FIG. 1, in accordance with example embodiments of the disclosure.

FIG. 4 is a flow diagram depicting an example method for fabricating the tricone bit of FIG. 1, in accordance with example embodiments of the disclosure.

FIG. 5 is a flow diagram depicting another example method for fabricating the tricone bit of FIG. 1, in accordance with example embodiments of the disclosure.

FIG. 6 is a schematic illustration of an example surface region 600 with a lubricant bi-layer on surfaces of the tricone bit, in accordance with example embodiments of the disclosure.

### DETAILED DESCRIPTION

Wherever possible, the same reference numbers will be used throughout the drawings to refer to the same or like parts.

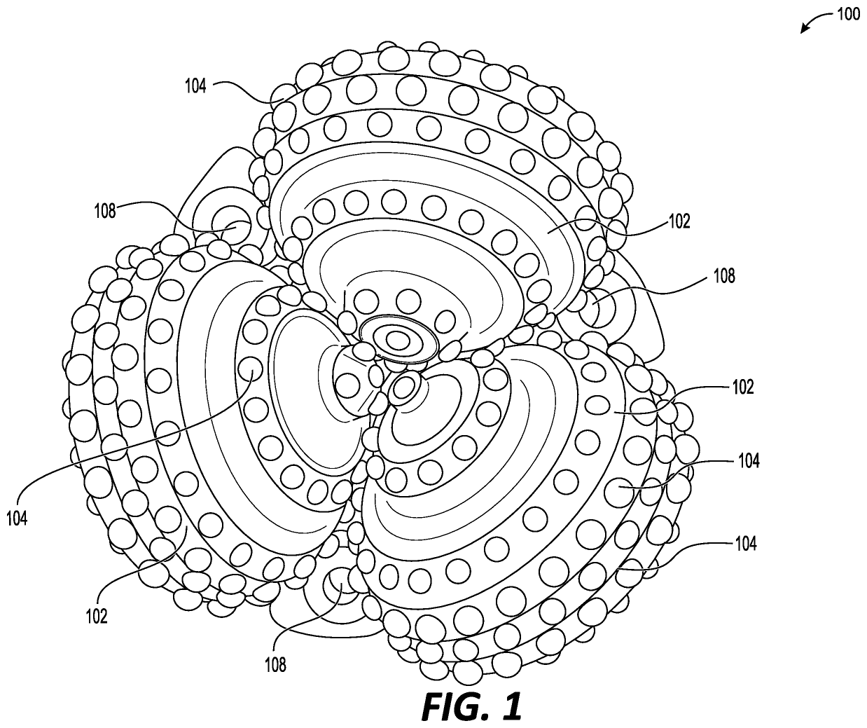

FIG. 1 is a schematic illustration of an example tricone bit 100, in accordance with example embodiments of the disclosure. The tricone bit 100, in some examples, may be an air-cooled tricone bit. In other words, internal components of the tricone bit 100 may be cooled by blown air or blown gas of any type (e.g., nitrogen, dry air, etc.). The tricone bit 100 may be configured for any variety of drilling operations, such as off-shore oil drilling, mineral ore drilling, or the like. The tricone bit 100, as depicted, may be part of an assembly that is mechanically coupled to a rotating shaft that provides rotational coupling during operation.

The tricone bit 100 includes three separate cones 102 that are in proximity to each other. As shown, the cones 102 may be substantially a conical or frustoconical shape and the nose portion of each of the cones 102 may be in greater proximity to each other than the base portion of each of the cones 102. Each of the cones 102 may be configured to rotate independently of each other. As such, one cone 102 may rotate on a first axis of rotation, a second cone 102 may rotate on a second axis of rotation, and a third cone 102 may rotate on a third axis of rotation. The first, second, and third axes are different from each other.

During operation, the three cones 102 rotate and the tricone bit 100 may be pushed, such as by a rotating shaft coupled to the tricone bit 100, against material (e.g., dirt, rock, etc.) that is to be drilled with the tricone bit 100. In this way, the tricone bit 100 is used to remove material during drilling. The tricone bit 100 may be used to drill any suitable materials, such as mineral ores, loose stone, gravel, soil, sand, concrete, dirt, silt, etc. Furthermore, the tricone bit 100 may be used for any suitable activity, such as oil drilling, construction, mining, farming, military, transportation, etc.

The cones 102 may have inserts or teeth 104 disposed on their surface. These teeth 104 allow the tricone bit 100 to cut into hard materials, such as any variety of rocks. As the cones 102 rotate in a manner where the teeth 104 are in contact with the material to be drilled, the teeth 104 dig or scrape into the material to be drilled, thereby removing the material and drilling the hole farther down. Additionally, the teeth 104 may crush drilled material to render that material easier to remove from the hole being drilled.

The cones 102 may be formed using any suitable materials, such as metals. For example, the cones 102 may be formed from steel (e.g., hardened carbon steel). In some cases, the cones may be surface treated to increase their hardness, such as by carburizing, hard facing, or the like. The teeth 104, as embedded within the surface of the cones 102, may be formed from any suitable materials, such as ceramic materials, metals, etc. The teeth 104, for example, may be formed from silicon carbide (SiC), alumina (Al₂O₃), tungsten carbide (WC), various metals, or the like. In some cases, the teeth 104 may be embedded into the surface of the cone 102. In other cases, the teeth 104 may be formed in an integrated fashion with the rest of the cone 102.

The tricone bit 100 may also include one or more blow nozzles 108. These blow nozzles 108 may be adjacent to the cones 102 and may be fluidically coupled to a conduit for pressurized gas. The pressurized gas may be of any suitable type, such as air. During operation, the tricone bit 100 may generate a considerable amount of dust from the material(s) being drilled. The blow nozzles 108 may be used to blow the dust away to clear virgin material to be drilled. In some cases, during operation, the tricone bit 100 may be pushed against the material to be drilled and then pulled away from the material to be drilled, such as in a reciprocating way. This may be done for various reasons, such as to reduce the thermal load on the tricone bit 100 and its internal components. In some cases, pressurized air may be blown through the blow nozzles 108 as the tricone bit 100 is pulled away from the material to be drilled. In this way, the area to be drilled can be cleared of debris and when the tricone bit 100 reengages the material to be drilled, a virgin surface of that material is available to be drilled, rather than dust obfuscating the surface of the material to be drilled.

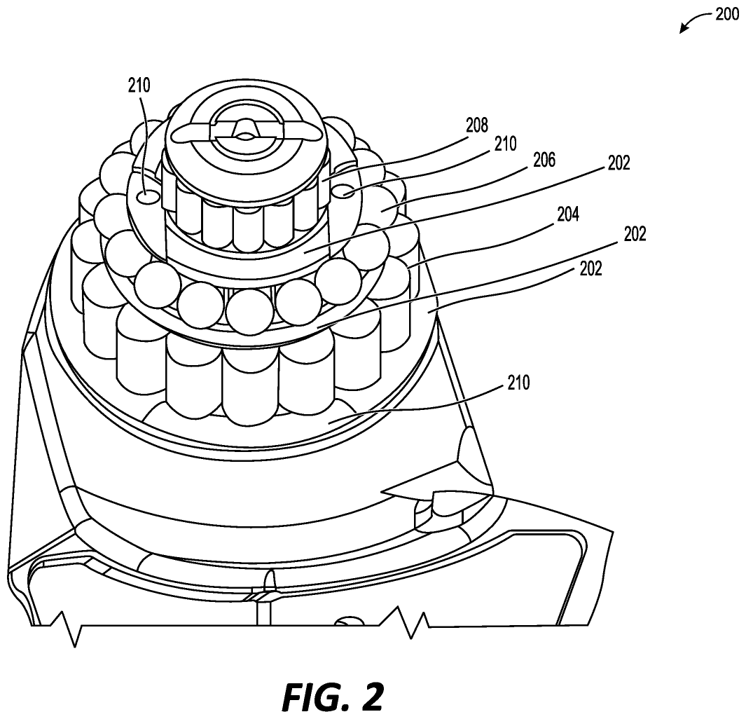

FIG. 2 is a schematic illustration of a journal base 200 and bearings of a cone 102 of the tricone bit of FIG. 1, in according to example embodiments of the disclosure. The journal base 200 may include one or more plates 202 to hold the bearing elements 204, 206, 208 of the tricone bit 100. The one or more plates 202 may be separable from the journal base 200 or integrally and/or positionally fixed on the journal base 200. The journal base 200 may further include air slots 210 for cooling the journal base 200, the bearing elements 204, 206, 208, and/or the cone 102.

The journal base 200 may be formed with any suitable material, such as any variety of metals or their alloys. For example, in some cases, the journal base 200 may be substantially formed with hardened steel. The journal base 200 is rotatably coupled to the corresponding cone 102, such that the cone 102 can rotate, while the journal base 200 remains stationary. In other words, the cone 102 rotates around its corresponding journal base 200 during operation of the tricone bit 100. Furthermore, each of the three cones 102 of the tricone bit 100 are configured to rotate around their corresponding journal bases 200 independent of each other. It is this rotational motion of the cone 102 relative to the journal base 200 that allows for the drilling of materials using the tricone bit 100.

The bearing elements 204, 206, 208, are shown as a particular set of stacked components of large rollers 204, balls 206, and small rollers 208. Additionally, the bearing elements 204, 206, 208 together form three separate bearings. However, this is merely an example configuration and example set of rolling elements and number of bearings. It should be understood that this disclosure applies to any suitable type and configuration of bearing elements 204, 206, 208. For example, the features of this disclosure may apply to a journal base 200 with only be two sets of bearings, such as with a set of large rollers and small rollers. Alternatively, the disclosure may apply to a journal base with other types of bearing elements 204, 206, 208, such as journal bearings or other non-rolling bearings. As another example, the tricone bit may include only ball bearings. Further still, the disclosure herein may apply to one or more bearings oriented in an orthogonal (or at another angle) relative to the other bearings of the journal base 200.

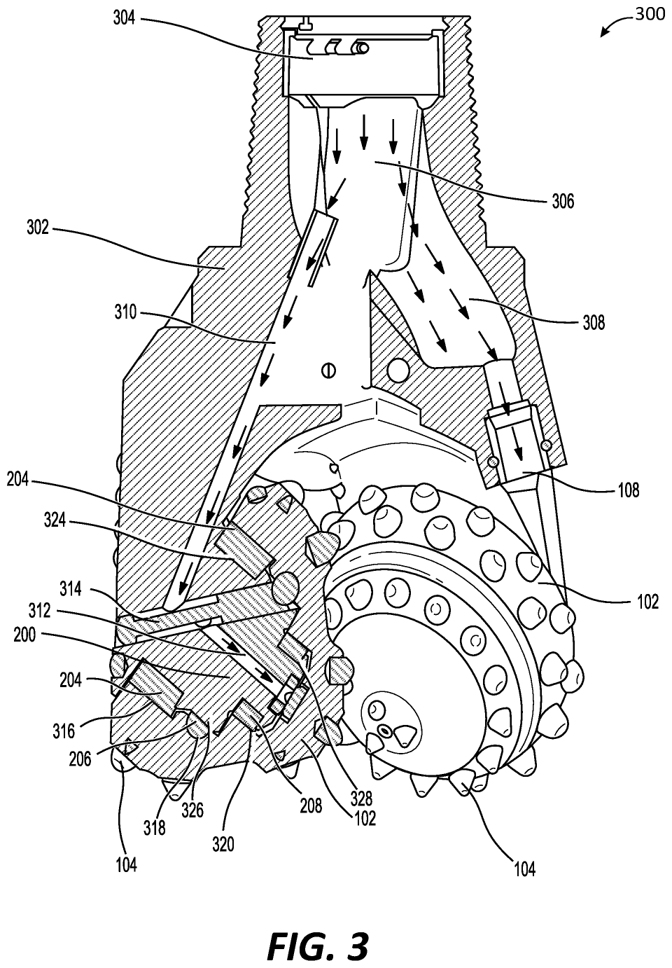

The air slots 210 may be fluidically coupled to a source of pressurized gas, such as pressurized air, as will be described in greater detail in conjunction with FIG. 3. The pressurized gas may be provided from a gas canister/tank, an air compressor, and/or from an air pump. In some cases, the pressurized gas may be a gas other than air or dry air, such as an air and water mixture or an air and oil mixture, to provide greater cooling capacity of the internal components of the tricone bit 100.

The internal components of the tricone bit 100 experience high operating temperatures and high levels of wear and tear, resulting from friction between internal parts of the tricone bit 100, such as the bearing elements 204, 206, and 208 and the journal base 200. It is desirable to have a more advantageous tribology of the internal components of the tricone bit 100. With a more advantageous tribology associated with the internal components of the tricone bits 100, the tricone bits 100 can operate at lower temperatures and experience reduced wear and tear. The disclosure herein provides a mechanism for providing a more advantageous tribology within the tricone bit 100 compared to conventional tricone bits.

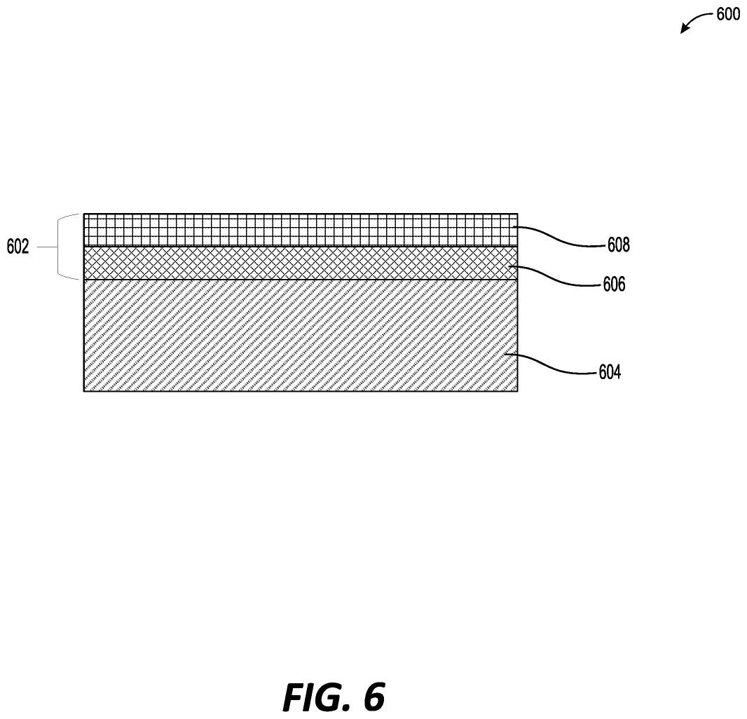

According to examples of the disclosure, the surfaces of the journal base 200 may be phosphated, by reacting the metal (e.g., steel, iron, zinc, etc.) of the journal base 200 with a phosphate containing solution, to form a metal-phosphate layer. According to additional examples of the disclosure, the surfaces of the journal base may be coated with an inorganic fullerene-like solid lubricant, such as tungsten disulfide (WS₂). According to further examples of the disclosure, the journal base 200 surfaces may first be phosphated to form a metal-phosphate layer and then the inorganic fullerene-like solid lubricant may be applied on top of the metal-phosphate layer. In this way, a bi-layer of lubricant may be formed on top of the surfaces of the journal base 200. The lubricant layer over a metal structure is further described in conjunction with FIG. 6 below:

According to further examples of the disclosure, components other than the surface of the journal base 200 may have lubricant layer(s) disposed thereon. For example, in some cases, the one or more of the larger rollers 204, the balls 206, and/or the small rollers 208 may have a lubricant layer formed thereon. Similar to the surface of the journal base 200, any one or more of the larger rollers 204, the balls 206, and/or the small rollers 208 may have a metal-phosphate layer, a solid lubricant layer, or both a metal-phosphide and a solid lubricant layer disposed thereon. In some cases, an inner surface of the cone 102, which is in contact with the larger rollers 204, the balls 206, and/or the small rollers 208, may also have a metal-phosphate layer, a solid lubricant layer, or both a metal-phosphide and a solid lubricant layer disposed thereon.

The metal-phosphate layer may be formed by immersing the components to be phosphated (e.g., the journal base 200, the bearing elements 204, 206, 208, and/or the cone 102) into a chemical bath containing reactants that will form the metal phosphate layer. For example, the chemical bath may include dilute phosphoric acid and one or more soluble salts of zinc, manganese, iron, or the like. The metal-phosphate layer may be of any suitable type including, but not limited to, zinc phosphate, manganese phosphate, iron phosphate, or the like. Alternatively, the chemical reactants for phosphating may be applied by spraying or sponging.

The solid lubricant may be applied by any suitable mechanism, such as by aerosolized spray and/or dipping in a solution having the solid lubricant. Alternatively, solid lubricant may be deposited using plasma-based processes. In some cases, all the various components of the tricone bit 100 may be coated with the solid lubricant by the same process, such as by aerosolized spray. In other cases, different parts of the tricone bit 100 may be coated with solid lubricant by different processes. For example, solid lubricant may be sprayed onto the journal base 200, while the large rollers 204, balls 206, and small rollers 208 may be dipped in a solution having the solid lubricant.

Any suitable solid lubricant may be used to coat the components of the tricone bit 100. In some cases, the solid lubricant may be an inorganic fullerene structured material, such as WS₂. Other solid lubricants that may be used may include molybdenum disulfide (MoS₂), graphite, graphene, bucky balls or indeed any other suitable solid lubricant. The solid lubricant may be of any suitable shape, including balls, tubes, sheets, etc. The solid lubricants may be of any suitable size, such as angstroms, nanometers, tens-of-nanometers, hundreds-of-nanometers, microns, tens-of-microns, or hundreds-of-microns. In one example range, the diameter of the solid lubricants may range from about 1 nanometer to about 1 micron. The WS₂ may be sourced or synthesized in any suitable mechanism, such as chemical reactions between metal oxides and sulfides.

A bi-layer of the lubricant, such as with the metal-phosphate and the solid lubricant may allow for a thicker lubrication surface region, with greater lifetime of the lubricant layer. Phosphating may be a self-limiting process that depends on a surface chemical reaction. Therefore, forming a thick metal-phosphate layer may be significantly more time consuming, and therefore, expensive compared to a thinner layer of metal-phosphate. As a result, a bi-layer deposited using different processes may allow for a thicker, and therefore more persistent, lubrication layer on the components of the tricone bit 100.

The bi-layer lubricant, as disclosed herein, has further advantages resulting from the morphology of the metal-phosphate layer and the size and shape of the solid lubricants. The metal-phosphate layer typically has surface porosity into which the overlying solid lubricants may stick, resulting in a greater persistence of the top solid lubricant layer. In other words, the bi-layer of lubricant, as disclosed herein, may result in greater lubricant persistence than each layer alone.

FIG. 3 is a schematic illustration of a tricone assembly 300 with a cross section of one cone 102 of the tricone bit 100 of FIG. 1, in according to example embodiments of the disclosure. The tricone assembly 300 may include a housing 302 on which the journal base 200 is disposed. The tricone assembly 300 may further include an air valve 304 to which a source of air or other gases, such as a pressurized canister of gas or an air pump, may be fluidically coupled. Air delivered via the air valve 304 is delivered to an air pathway 306 to be conducted to a first air conduit 308 and a second air conduit 310. The air valve 304 may allow the tricone assembly 300 to be connected to a source of pressurized gas, such as a pressurized air canister (not shown) or a pump. The air valve 304, in some cases, may serve to prevent backflow of air from the tricone bit 100. In other words, the air valve 304 may serve the purpose of only allowing air to flow to the tricone bit 100, rather than from the tricone bit 100.

The first air conduit 308 conducts the air or gas to blow nozzles 108. The second air conduit 310, which conducts gas to a third air conduit 312 within individual ones of the journal base 200, conducts air to the air slots 210 for internal cooling of each of the journal bases 200 and their associated cones 102. As discussed herein, the blow nozzles 108 may be used to blow debris away from the surfaces being drilled. As the tricone bit 100 gets used, the loads on the tricone bit 100 generate heat, such as by friction between the internal components of the tricone bit 100. The air conducted via the air conduit 310 and air conduit 312 and to the air slots 210 cool the internal components (e.g., the journal bases 200, the bearing elements 204, 206, 208, etc.) of the tricone bit 100, such as by convection cooling.

The journal base 200 may also include a retaining pin 314. The retaining pin 314 may be configured to insert the bearing balls 206 between the journal base 200 and the cone 102 via a through-hole of the journal base 200. The retaining pin 314 may further be configured to hold the bearing balls 206 and/or other internal components in place during operation of the tricone bit 100. Thus, the retaining pin 314 may be useful during the fabrication/manufacture of the tricone bit 100 or during the use of the tricone bit 100 or both during the fabrication and use of the tricone bit 100.

The cone 102 may include surfaces 316, 318, 320 adjacent to the bearing elements 204, 206, 208, respectively. These surfaces 316, 318, 320 may serve as raceway's (e.g., outer raceway) of bearings formed by the bearing elements 204, 206, 208, respectively. In examples of the disclosure, the surfaces 316, 318, 320 may be coated with the phosphate layer and/or the solid lubricant over the phosphate layer. In some cases, the entire inner surface of the cone 102 may be coated with the metal-phosphate layer and/or the solid lubricant layer, including the surfaces 316, 318, 320. By coating the entirety of the inner surface of the cone 102 with one or both lubricant layers, at least the surfaces 316, 318, 320 that form the outer raceways of the bearings of the tricone bit 100 are also coated. The addition lubricant layers coated on the non-raceway areas of the cone 102 do not interfere with the operations of the tricone bit 100.

The journal base 200 may include surfaces 324, 326, 328 adjacent to the bearing elements 204, 206, 208, respectively. These surfaces 324, 326, 328 may serve as raceway's (e.g., inner raceway) of bearings formed by the bearing elements 204, 206, 208, respectively. In examples of the disclosure, the surfaces 324, 326, 328 may be coated with the phosphate layer and/or the solid lubricant over the phosphate layer. In some cases, the entire surface of the journal base 200 may be coated with the metal-phosphate layer and/or the solid lubricant layer, including the surfaces 324, 326, 328. Because the lubricant layers, as described herein as a metal-phosphate layer with an overlying solid lubricant layer are so thin, it is hard to see in the illustration of FIG. 3. The lubricant layer is depicted in FIG. 6.

The thickness of the metal-phosphate layer may be of any suitable thickness. In some cases, the metal-phosphate layer may be in the range of about 0.5 microns (μm) to about 20 μm. In other cases, the metal-phosphate layer may be in the range of about 1 μm to about 10 μm. In some further cases, the metal-phosphate layer may be in the range of about 1.5 μm to about 7 μm. In yet other cases, the metal-phosphate layer may be in the range of about 2 μm to about 5 μm. In one example, the metal-phosphate layer may be approximately 4 μm thick.

The thickness of the solid lubricant layer may be of any suitable thickness. In some cases, the solid lubricant layer may be in the range of about 0.5 μm to about 20 μm. In other cases, the solid lubricant layer may be in the range of about 1 μm to about 15 μm. In some further cases, the solid lubricant layer may be in the range of about 2 μm to about 10 μm. In yet other cases, the solid lubricant layer may be in the range of about 4 μm to about 7 μm. In one example, the solid lubricant layer may be approximately 5 μm thick.

It should be understood that while the disclosure is described in the context of an air-cooled tricone bit 100, the systems, apparatus, and methods disclosed herein may be applied to sealed tricone bits, grease-cooled tricone bits, or any other applications that utilize bearings to reduce friction in rotating applications. In other words, the bi-layer of solid lubricant overlying a metal-phosphate layer may improve the operations of any variety of bearings in any variety of applications, such as automotive applications, aeronautical applications, construction applications, or the like.

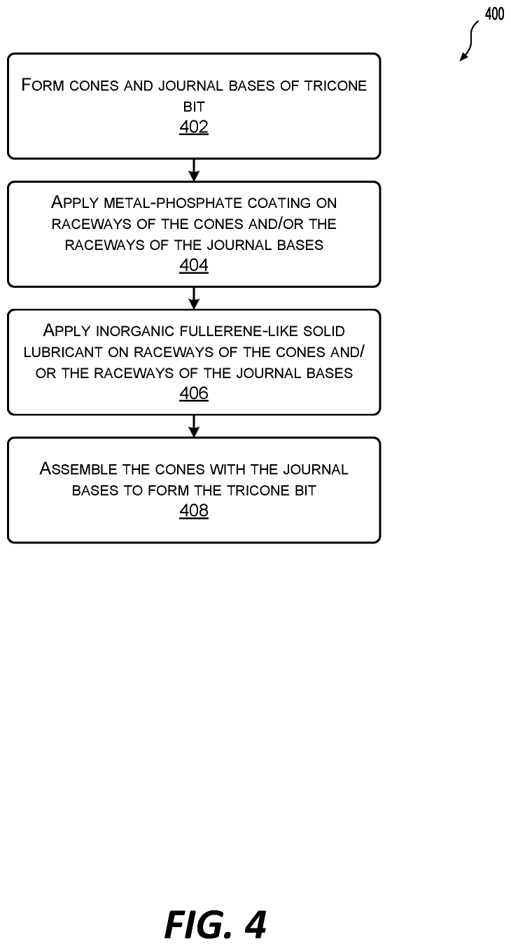

FIG. 4 is a flow diagram depicting an example method 400 for fabricating a tricone bit of FIG. 1, according to example embodiments of the disclosure. The method 400 may be performed by a single entity or multiple entities. As such, portions may be performed by an original equipment manufacturer (OEM) or component manufacturers of the tricone bit 100, as disclosed herein. The tricone bit 100, as disclosed herein, may be of any suitable type, such as an air-cooled tricone bit 100, a grease-cooled tricone bit with a grease reservoir, or the like.

At block 402, the cones 102 and the journal bases 200 may be formed. In some cases, three of each of the cones 102 and journal bases 200 may be formed to assemble one of the tricone bit 100. The cones 102 and/or journal bases 200 may be formed from any suitable material, such as steel, iron, or the like. The cones 102 and/or journal bases 200 may be formed by any suitable mechanism, such as forging, casting, sand casting, extrusion, or the like.

In some cases, the cones 102 or the journal bases 200 may be treated after formation, such as to provide hard surfaces. For example, the cones and/or journal bases 200 may be formed by steel casting and then undergo a carburization process to increase the carbon content in the surfaces, such as surfaces 316, 318, 320, 324, 326, 328, which may serve as raceways (e.g., inner raceways or outer raceways) of the cones 102 and/or journal bases 200. This allows for hard raceway surfaces, such as the outer surface region of the journal bases 200 and/or the inner surface region of the cones 102, while maintaining a softer core region of the journal bases 200 and/or the cones 102 for relatively high levels of toughness. Other mechanisms for achieving a hard surface region may include hard facing.

In some cases, the journal bases 200 may be fabricated (e.g., sand cast) in an integrated fashion with each other. For example, all three of the journal bases 200 may be formed in a single piece. In some cases, the journal bases 200 may further be fabricated integrally with the housing 302. It should be understood that the processes disclosed herein apply to various ways and partitions of forming the journal bases 200 and/or the cones 102.

At block 404, the raceways of the cones 102 and/or the raceways of the journal bases 200 are coated with metal-phosphate coating. The raceways, as defined herein, are surface portions of the cones 102 and/or the journal bases 200, such as surfaces 316, 318, 320 of the cones 102 and/or surfaces 324, 326, 328 of the journal bases 200. The metal-phosphate layer may be formed by immersing the components to be phosphated (e.g., the journal base 200, the bearing elements 204, 206, 208, and/or the cone 102) into a chemical bath containing reactants that will form the metal phosphate layer. For example, the chemical bath may include dilute phosphoric acid and one or more soluble salts of zinc, manganese, iron, or the like. The metal-phosphate layer may be of any suitable type including, but not limited to, zinc phosphate, manganese phosphate, iron phosphate, or the like. Alternatively, the chemical reactants for phosphating may be applied by spraying or sponging. In some cases, the surfaces to be coated with the metal-phosphate layer may be pretreated, such as by using an acid wash or a basic wash to remove any oils, grime, oxides, corrosion, or the like, to provide a uniform metal-phosphate coating on the surfaces to be coated.

The metal-phosphate layer may be formed with any suitable thickness. In some cases, the metal-phosphate layer may be deposited with a thickness in the range of about 0.5 μm to about 20 μm. In other cases, the metal-phosphate layer may be deposited with a thickness in the range of about 1 μm to about 10 μm. In some further cases, the metal-phosphate layer may be deposited with a thickness in the range of about 1.5 μm to about 7 μm. In yet other cases, the metal-phosphate layer may be deposited with a thickness in the range of about 2 μm to about 5 μm. In one example, the metal-phosphate layer may be deposited with a thickness of approximately 4 μm.

At block 406, the raceways of the cones 102 and/or the raceways of the journal bases 200 are coated with the solid lubricant. The solid lubricant may be applied by any suitable mechanism, such as by aerosolized spray and/or dipping in a solution having the solid lubricant. Alternatively, solid lubricant may be deposited using plasma-based processes. In some cases, all the various components of the tricone bit 100 may be coated with the solid lubricant by the same process, such as by aerosolized spray. In other cases, different parts of the tricone bit 100 may be coated with solid lubricant by different processes. For example, solid lubricant may be sprayed onto the journal base 200, while the large rollers 204, balls 206, and small rollers 208 may be dipped in a solution having the solid lubricant.

Any suitable solid lubricant may be used to coat the components of the tricone bit 100. In some cases, the solid lubricant may be an inorganic fullerene structured material, such as WS₂. Other solid lubricants that may be used may include MoS₂, graphite, graphene, bucky balls or indeed any other suitable solid lubricant. The solid lubricant may be of any suitable shape, including balls, tubes, sheets, etc. The solid lubricants may be of any suitable size, such as angstroms, nanometers, tens-of-nanometers, hundreds-of-nanometers, microns, tens-of-microns, or hundreds-of-microns. In one example range, the diameter of the solid lubricants may range from about 1 nanometer to about 1 micron. The WS₂ or other fullerenes may be sourced or synthesized in any suitable mechanism, such as chemical reactions between metal oxides and sulfides.

The thickness of the solid lubricant layer may be formed with any suitable thickness. In some cases, the solid lubricant layer may be deposited with a thickness in the range of about 0.5 μm to about 20 μm. In other cases, the solid lubricant layer may be deposited with a thickness in the range of about 1 μm to about 15 μm. In some further cases, the solid lubricant layer may be deposited with a thickness in the range of about 2 μm to about 10 μm. In yet other cases, the solid lubricant layer may be deposited with a thickness in the range of about 4 μm to about 7 μm. In one example, the solid lubricant layer may be deposited to have a thickness of approximately 5 μm.

At block 408, the cones 102 and the journal bases 200 may be assembled together. At this point one or both of the cones 102 and/or the journal bases 200 may have the bi-layer lubricant deposited on their raceway portions, by way of the operations of blocks 404 and 406. As will be understood, surfaces other than just the raceways may also be coated, at this point, with the bi-layer lubricant. For example, while surfaces 324, 326, 328 of the journal bases 200 may be coated with the bi-layer lubricant, the remainder of the outside surface of the journal bases 200 may also be coated with the bi-layer lubricant, as disclosed herein. Similarly, for the cone 102, in addition to surfaces 316, 318, 320 being coated, the entirety of the cone 102 inner surfaces and/or all of the cone 102 surfaces may be coated with the bi-layer lubricant. Thus, at this point the tricone bit 100 will have a persistent lubrication of internal moving and/or contact parts, such as the raceways of one or both of the journal bases 200 and/or the cones 102.

As discussed herein, one of the processes of blocks 404 or 406 may be optional. In other words, according to examples of this disclosure, one or more of the internal components of the tricone bit 100 may only be coated with the metal-phosphate layer or only the solid lubricant layer or both the metal-phosphate layer and then the solid lubricant layer.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

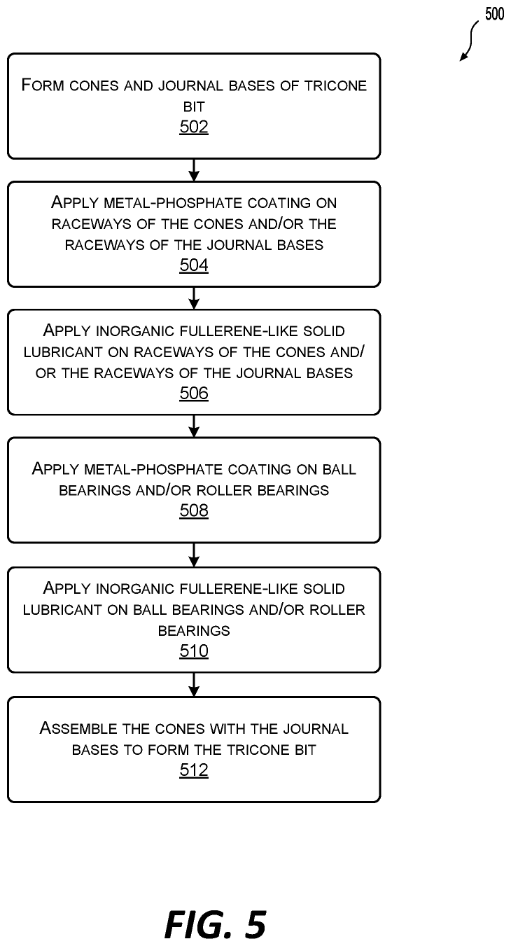

FIG. 5 is a flow diagram depicting another example method 500 for fabricating the tricone bit of FIG. 1, in accordance with example embodiments of the disclosure. The method 500 may be performed by a single entity or multiple entities. As such, portions may be performed by an OEM or component manufacturers of the tricone bit 100, as disclosed herein. The tricone bit 100, as disclosed herein, may be of any suitable type, such as an air-cooled tricone bit 100, a grease-cooled tricone bit with a grease reservoir, or the like. The method 500 may be similar to method 400 of FIG. 4, except that in method 500, one or more of the bearing elements 204, 206, 208 may have a single layer or a bi-layer of lubricant. Thus, according to method 500, substantially all of the moving components of the tricone bit 100 may be lubricated for improved tribological performance. The descriptions of blocks 502, 504, and 506 are substantially similar to the descriptions of blocks 402, 404, and 406 of method 400 of FIG. 4, and in the interest of brevity, will not be repeated here.

At block 508, a metal-phosphate coating is applied to the ball bearings 206 and/or the roller bearings 204, 208. The metal-phosphate layer may be formed by immersing the components to be phosphated (e.g., the bearing elements 204, 206, 208) into a chemical bath containing reactants that will form the metal phosphate layer. For example, the chemical bath may include dilute phosphoric acid and one or more soluble salts of zinc, manganese, iron, or the like. The metal-phosphate layer may be of any suitable type including, but not limited to, zinc phosphate, manganese phosphate, iron phosphate, or the like. Alternatively, the chemical reactants for phosphating may be applied by spraying or sponging. In some cases, the surfaces to be coated with the metal-phosphate layer may be pretreated, such as by using an acid wash or a basic wash to remove any oils, grime, oxides, corrosion, or the like, to provide a uniform metal-phosphate coating on the surfaces to be coated.

The metal-phosphate layer may be formed with any suitable thickness. In some cases, the metal-phosphate layer may be deposited with a thickness in the range of about 0.5 μm to about 20 μm. In other cases, the metal-phosphate layer may be deposited with a thickness in the range of about 1 μm to about 10 μm. In some further cases, the metal-phosphate layer may be deposited with a thickness in the range of about 1.5 μm to about 7 μm. In yet other cases, the metal-phosphate layer may be deposited with a thickness in the range of about 2 μm to about 5 μm. In one example, the metal-phosphate layer may be deposited with a thickness of approximately 4 μm.

At block 510, an inorganic fullerene-like solid lubricant is applied to the ball bearings 206 and/or the roller bearings 204, 208. The solid lubricant may be applied by any suitable mechanism, such as by aerosolized spray and/or dipping in a solution having the solid lubricant. Alternatively, solid lubricant may be deposited using plasma-based processes. In some cases, all the various components of the tricone bit 100 may be coated with the solid lubricant by the same process, such as by aerosolized spray. In other cases, different parts of the tricone bit 100 may be coated with solid lubricant by different processes.

Any suitable solid lubricant may be used to coat the bearing elements 204, 206, 208. In some cases, the solid lubricant may be an inorganic fullerene structured material, such as WS₂. Other solid lubricants that may be used may include MoS₂, graphite, graphene, bucky balls or indeed any other suitable solid lubricant. The solid lubricant may be of any suitable shape, including balls, tubes, sheets, etc. The solid lubricants may be of any suitable size, such as angstroms, nanometers, tens-of-nanometers, hundreds-of-nanometers, microns, tens-of-microns, or hundreds-of-microns. In one example range, the diameter of the solid lubricants may range from about 1 nanometer to about 1 micron. The WS₂ or other fullerenes may be sourced or synthesized in any suitable mechanism, such as chemical reactions between metal oxides and sulfides.

The thickness of the solid lubricant layer may be formed with any suitable thickness. In some cases, the solid lubricant layer may be deposited with a thickness in the range of about 0.5 μm to about 20 μm. In other cases, the solid lubricant layer may be deposited with a thickness in the range of about 1 μm to about 15 μm. In some further cases, the solid lubricant layer may be deposited with a thickness in the range of about 2 μm to about 10 μm. In yet other cases, the solid lubricant layer may be deposited with a thickness in the range of about 4 μm to about 7 μm. In one example, the solid lubricant layer may be deposited to have a thickness of approximately 5 μm.

At block 512, the cones 102 and the journal bases 200 may be assembled together. At this point the cones 102, the journal bases 200, and/or the bearing elements 204, 206, 208 may have the bi-layer lubricant deposited on their surfaces, by way of the operations of blocks 504, 506, 508, and 510. At this point the tricone bit 100 will have a persistent lubrication of internal moving and/or contact parts, such as the raceways of one or both of the journal bases 200 and/or the cones 102.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

FIG. 6 is a schematic illustration of an example surface region 600 with a lubricant bi-layer 602 on various surfaces 604 of the tricone bit 100, in accordance with example embodiments of the disclosure. The surface 604 may be any suitable surface, including a raceway (e.g., inner raceway or outer raceway) of a bearing, the surfaces 316, 318, 320 of the cone 102, surfaces 324, 326, 328 of the journal base 200, the entire outer surface of the journal base 200, the entire inner surface of the cone 102, the entire surface of the cone 102, and/or the surfaces of bearing elements 204, 206, 208. The surface region 600 includes the native surface 604 of the component that is coated, as well as the lubricant bi-layer 602.

As discussed herein, the lubricant bi-layer 602 includes a metal-phosphate layer 606 disposed over the surface 604 and a solid lubricant layer 608 disposed over the metal-phosphate layer 606. Although the metal-phosphate layer 606 and the solid lubricant layer 608 are depicted as uniform and smooth at their interfaces, it should be understood that the metal-phosphate layer 606 and/or the solid lubricant layer 608 may not be entirely uniform in thickness throughout or without topography. In some cases, the metal-phosphate layer 606 may include a somewhat porous surface morphology that may enhance the persistence of the solid lubricant layer 608 thereon. In this way, the topography of the metal-phosphate layer 606 and/or the size and shape of particles of the solid lubricant layer 608 together may enhance the persistence of the lubricant bi-layer 602.

It should be understood that a thicker and more cost effective lubricant bi-layer 602 is disclosed herein. The metal-phosphate deposition process may be self-limiting, where, as the thickness of metal-phosphate layer thickens, the deposition rate may slow down. Thus, it may be more costly and/or time consuming per unit thickness to deposit a thick layer of metal-phosphate compared to a thinner layer of metal-phosphate. The lubricant bi-layer 602, as disclosed herein, allows for a thicker, and therefore more persistent lubricant, without having to deposit the whole lubricant using a self-limiting process.

As disclosed herein, the thickness of the metal-phosphate layer 606 may be of any suitable thickness. In some cases, the metal-phosphate layer 606 may be in the range of about 0.5 μm to about 20 μm. In other cases, the metal-phosphate layer 606 may be in the range of about 1 μm to about 10 μm. In some further cases, the metal-phosphate layer 606 may be in the range of about 1.5 μm to about 7 μm. In yet other cases, the metal-phosphate layer 606 may be in the range of about 2 μm to about 5 μm. In one example, the metal-phosphate layer 606 may be approximately 4 μm thick.

As disclosed herein, the thickness of the solid lubricant layer 608 may be of any suitable thickness. In some cases, the solid lubricant layer 608 may be in the range of about 0.5 μm to about 20 μm. In other cases, the solid lubricant layer 608 may be in the range of about 1 μm to about 15 μm. In some further cases, the solid lubricant layer 608 may be in the range of about 2 μm to about 10 μm. In yet other cases, the solid lubricant layer 608 may be in the range of about 4 μm to about 7 μm. In one example, the solid lubricant layer 608 may be approximately 5 μm thick.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosure.

### INDUSTRIAL APPLICABILITY

The present disclosure describes systems and methods for extending the operating lifetime of tricone bits 100, such as air-cooled tricone bits 100. The tricone bits 100, as disclosed herein, include one or more bearings formed by bearing elements 204, 206, 208 disposed between the cones 102 and the journal bases 200 or the tricone bits 100. Conventional air-cooled tricone bits 100 lack any persistent lubrication in the internal components, such as raceways (e.g., surfaces 316, 318, 320, 324, 326, 328) of the cones 102 and/or the journal bases 200, of the air-cooled tricone bits. At most, conventional air-cooled tricone bits may come with a small amount of grease applied to some of the internal components and that grease may last for an initial several seconds or minutes of operation, at which point the conventional tricone bits lack any lubrication for the remainder of its lifetime. Such an operation, where the initial lubrication is no longer present throughout most of the operation of the tricone bit 100 may severely decrease the lifetime of conventional air-cooled tricone bits.

The disclosure herein provides a more persistent lubrication for the moving parts (e.g., bearings formed by sandwiching the bearing elements 204, 206, 208 between the cone 102 and the journal base 200) during the operation of the tricone bit. The technological advances presented herein can provide a benefit to any type of tricone bit, such as a sealed grease-cooled tricone bit. However, the advantages of this disclosure may be particularly beneficial for air-cooled tricone bits 100, which conventionally do not have persistent lubrication beyond just an initial greasing prior to first use. Additionally, the system(s) and mechanisms disclosed herein lend themselves to greater thermal efficiencies for not just tricone bits 100, but also bearings for other applications, such as transportation applications.

The tricone bits 100 fabricated according to the disclosure herein provide more persistent than conventional lubrication, resulting in reduced friction between components of the tricone bits 100. The reduced friction in tricone bits 100, and/or bearings in general, result in reduced operating temperatures, as well as reduced wear and tear and increased operating lifetimes. The increased operating lifetimes result in reduced number of tricone bits 100 needed for completing drilling projects. Furthermore, the increased operating lifetimes decrease the need to stop operations of drilling projects to change the tricone bit 100. Thus, the disclosure enables greater uptime of drilling projects and reduced material usage. Therefore, the disclosure results in greater efficiencies and greater return on investment (ROI) and return on capital (ROC) compared to conventionally fabricated tricone bits.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A tricone bit assembly, comprising:
a first journal base having a first surface region, wherein the first surface region includes a metal-phosphate layer and a solid lubricant layer overlying the metal-phosphate layer;
a first cone rotatably mounted on the first journal base and configured to rotate on a first axis; and
at least one rolling element disposed between the first journal base and the first cone, such that the at least one rolling element enables the first cone to rotate relative to the first journal, wherein the at least one rolling element is substantially in contact with at least one of the solid lubricant layer or the metal-phosphate layer.

2. The tricone bit assembly of claim 1, wherein the solid lubricant layer comprises inorganic fullerene materials.

3. The tricone bit assembly of claim 1, wherein the solid lubricant layer comprises tungsten sulfide (WS₂).

4. The tricone bit assembly of claim 1, wherein the metal-phosphate layer comprises at least one of zinc phosphate, manganese phosphate, or iron phosphate.

5. The tricone bit assembly of claim 1, further comprising:
an air conduit to conduct air for cooling the at least one rolling element.

6. The tricone bit assembly of claim 1, wherein the at least one rolling element comprises a small roller, a large roller, and a ball.

7. The tricone bit assembly of claim 1, further comprising:
a second journal base having a second surface region, wherein the second surface region includes a second metal-phosphate layer and a second solid lubricant layer overlying the second metal-phosphate layer; and
a second cone rotatably mounted on the second journal base and configured to rotate on a second axis different from the first axis.

8. The tricone bit assembly of claim 7, further comprising:
a plurality of second rolling elements disposed between the second journal base and the second cone, such that the plurality of the second rolling elements enable the second cone to rotate relative to the second journal, wherein the plurality of the second rolling elements are substantially in contact with at least one of the second solid lubricant layer or the second metal-phosphate layer.

9. The tricone bit assembly of claim 1, wherein the at least one rolling element comprises a second surface region including a second metal-phosphate layer and a second solid lubricant layer overlying the second metal-phosphate layer.

10. A method of fabricating a tricone bit, comprising:
fabricating a first journal base with an outer surface;
depositing a first metal-phosphate layer on the outer surface of the first journal base;
depositing a first solid lubricant layer on top of the first metal-phosphate layer;
fabricating a first cone; and
assembling the first cone over the first solid lubricant layer disposed on the first journal base with at least one rolling element disposed between the first solid lubricant layer and the first cone.

11. The method of fabricating a tricone bit of claim 10, wherein the first solid lubricant layer comprises tungsten sulfide (WS₂).

12. The method of fabricating a tricone bit of claim 10, wherein the first metal-phosphate layer comprises at least one of zinc phosphate, manganese phosphate, or iron phosphate.

13. The method of fabricating a tricone bit of claim 10, wherein the first cone includes an inner surface, the method further comprising:
depositing a second metal-phosphate layer on the inner surface of the first cone; and
depositing a second solid lubricant layer on top of the second metal-phosphate layer.

14. The method of claim 13, wherein the at least one rolling element includes an outer surface, the method further comprising:
depositing a third metal-phosphate layer on the outer surface of the first journal base; and
depositing a third lubricant layer on top of the third metal-phosphate layer.

15. The method of claim 10, further comprising:
fabricating a second journal base with a second outer surface;
depositing a second metal-phosphate layer on the second outer surface of the second journal base;
depositing a second solid lubricant layer on top of the second metal-phosphate layer;
fabricating a second cone; and
assembling the second cone over the second solid lubricant layer disposed on the second journal base with at least one second rolling element disposed between the second solid lubricant layer and the second cone.

16. A bearing, comprising:
an inner raceway surface region, wherein the inner raceway surface region includes a metal-phosphate layer and a solid lubricant layer overlying the metal-phosphate layer;
an outer raceway surface region rotatably configured to rotate relative to the inner raceway surface region; and
at least one rolling element disposed between the inner raceway surface region and the outer raceway surface region, such that the at least one rolling element enables the outer raceway surface to rotate relative to the inner raceway surface region, wherein the at least one rolling element is substantially in contact with at least one of the solid lubricant layer or the metal-phosphate layer.

17. The bearing of claim 16, wherein the at least one rolling element comprises a surface region including a second metal-phosphate layer and a second solid lubricant layer overlying the second metal-phosphate layer.

18. The bearing of claim 16, wherein the outer raceway surface region includes a second metal-phosphate layer and a second solid lubricant layer overlying the second metal-phosphate layer.

19. The bearing of claim 16, wherein the inner raceway surface region is disposed on a journal base and the outer raceway surface region is disposed on a cone.

20. The bearing of claim 16, wherein the solid lubricant layer comprises tungsten sulfide (WS₂).
